(19) United States
(12) Patent Application Publication
(10) Pub. No.: US 2012/0312455 A1
(43) Pub. Date: Dec. 13, 2012

(54) PNEUMATIC TIRE MOLDING METHOD AND MOLDING APPARATUS

(75) Inventor: Noboru TAKADA, Hiratsuka-shi (JP)

(73) Assignee: THE YOKOHAMA RUBBER CO., LTD., Tokyo (JP)

(21) Appl. No.: 13/453,414

(22) Filed: Apr. 23, 2012

(30) Foreign Application Priority Data
Jun. 8, 2011 (JP) 2011-128218

(51) Int. Cl. B29D 30/72; B29D 30/00

(52) U.S. Cl. 156/133; 156/421.6

(57) ABSTRACT

A pneumatic tire molding method and apparatus enable a side member to be attached to a tire component member set on an external circumferential surface of a rigid inner mold with intimate contact while preventing deformation of the side member surface shape. An annular recess in an annular holder covers an area corresponding to a tire side section of a carcass material on an external circumferential surface of a circular-cylindrically shaped rigid inner mold having substantially the same shape as a profile of an internal circumferential surface of a tire to be manufactured. Air is sucked from a space between the recess and carcass to reduce space pressure. A holding part is arranged inside the recess, has a holding surface having the same shape as a side member surface, and attaches the side member to the reduced pressure area. Remaining tire components are attached to complete a green tire.

### CROSS-REFERENCE TO RELATED APPLICATION

This application claims priority under 35 U.S.C. §119(a) to Japanese Patent Application No. 2011-128218, filed in Japan on Jun. 8, 2011, the entire contents of Japanese Patent Application No. 2011-128218 are hereby incorporated herein by reference.

### BACKGROUND

1. Field of the Invention

The present invention relates to a pneumatic tire molding method and molding apparatus. More particularly, the present invention relates to a pneumatic tire molding method and molding apparatus that enables a side member to be attached to a tire component member set on an external circumferential surface of a rigid inner mold with intimate contact while preventing a surface shape of the side member from undergoing deformation.

2. Background Information

Various pneumatic tire manufacturing methods have been proposed, such as that disclosed in Japanese Laid-open Patent Publication No. 2009-149034, in which a green tire is molded on an external circumferential surface of a rigid inner mold made of metal and the molded green tire is arranged inside a vulcanization mold together with the rigid inner mold and vulcanized. With a manufacturing method using this kind of rigid inner mold, a load acting against the green tire during vulcanizing can be reduced because the green tire has a shape that is close to the shape of the tire resulting after vulcanization.

However, it is necessary to mold the green tire to have substantially the same shape as the tire to be manufactured when the green tire is molded on the rigid inner mold. In particular, it is preferable to attach the side member to a carcass material wrapped onto the external circumferential surface of the rigid inner mold without deforming a preset surface shape of the side member. Additionally, it is important to attach the side member such that it makes intimate contact with the carcass material without trapping air between the side member and the carcass material. Strongly pressing the side member is effective for achieving intimate contact, but this method can be problematic because applying an excessive pressing force can cause the surface shape of the un-vulcanized side member to deform. Thus, with the conventional method, it is difficult to attach a side member to a tire component member set on the external circumferential surface of an inner mold such that intimate contact is achieved while preventing deformation of the surface shape of the side member.

### SUMMARY

An object of the present invention is to provide a pneumatic tire molding method and molding apparatus with which when a side member is attached to a tire component member set on an external circumferential surface of a rigid inner mold, the side member can be attached with intimate contact while preventing a surface shape of the side member from undergoing deformation.

In order to achieve the aforementioned object, a pneumatic tire molding method according to the present invention is a pneumatic tire molding method for molding a green tire on an external circumference of a circular-cylindrically shaped rigid inner mold whose external circumferential surface has substantially the same shape as a profile of an internal circumferential surface of a tire to be manufactured. The method includes a step in which an annular recess formed in an annular holder is arranged side-by-side with and made to cover an area corresponding to a tire side section of a tire component member arranged on an external circumferential surface of the rigid inner mold. The method further includes a subsequent step in which air is sucked from a space between the recess and the tire component member covered by the recess so as to reduce a pressure in the space, a surface of a side member is held by a holding part having a holding surface with the same shape as the surface of the side member, and the side member is pressed against and attached to the area corresponding to the tire side section under the pressure-reduced state. The method also includes a step in which a green tire is molded by attaching remaining tire component members to the tire component member arranged on the external circumferential surface of the rigid inner mold.

A pneumatic tire molding apparatus according to the present invention is a pneumatic tire molding apparatus for molding a green tire on an external circumference of circular-cylindrically shaped rigid inner mold whose external circumferential surface has substantially the same shape as a profile of an internal circumferential surface of a tire to be manufactured. The apparatus comprises an annular holder, a pump, and a holding part. The annular holder can move in directions of approaching toward and separating from an area corresponding to a tire side section of a tire component member arranged on the external circumferential surface of the rigid inner mold, and the annular holder has an annular recess that can cover the area corresponding to the tire side section. The pump is connected to the recess through a suction line that communicates with the recess. The holding part is arranged inside the recess, has a holding surface shaped the same as a surface of the side member, and is configured to hold the surface of the side member with the holding surface.

With the present invention, the annular recess formed in the annular holder is arranged side-by-side with and made to cover the area corresponding to the tire side section of the tire component member arranged on the external circumferential surface of the rigid inner mold and air is sucked from a space between the recess and the tire component member covered by the recess so as to reduce the pressure in the space. Thus, the side member can be pressed against and attached to the area corresponding to the tire side section under this pressure-reduced state. Additionally, since the surface of the side member is held by the holding surface having the same shape as the surface of the side member, the side member can be attached with intimate contact to the area corresponding to the tire side section while preventing deformation of the surface shape of the side member.

With a pneumatic tire molding method according to the present invention, when the side member is held by the holding part, the side member can be adhered to the holding surface with suction by sucking air through a suction hole opened in the holding surface. In this way, the side member can be held more reliably by the holding part without deforming the surface shape of the side member.

Within the recess, the holding part can be slid toward the area corresponding to the tire side section using pneumatic pressure such that the side member is pressed against the area corresponding to the tire side section. In this way, the side member can be attached more reliably to the area corresponding to the tire side section with intimate contact without applying excessive pressure against the side member.

A pneumatic tire molding apparatus according to the present invention can be configured to have a suction hole opened in the holding surface and a pump that sucks air through the suction hole. With such a configuration, the side member can be held more reliably by the holding part without deforming the surface shape of the side member.

The apparatus can be configured to have a sliding mechanism that uses pneumatic pressure to slide the holding part within the recess in directions of approaching toward and separating from the area corresponding to the tire side section. With such a configuration, the side member can be attached more reliably to the area corresponding to the tire side section with intimate contact without applying excessive pressure against the side member.

### BRIEF DESCRIPTION OF THE DRAWINGS

FIG. 1 is a vertical sectional view schematically illustrating an entire pneumatic tire molding apparatus according to a disclosed embodiment;

FIG. 2 is a cross sectional view taken along section line A-A of FIG. 1;

FIG. 3 is an enlarged partial vertical sectional view illustrating a step of holding a side member with a holding part;

FIG. 4 is an enlarged partial vertical sectional view illustrating a step of arranging an annular recess side-by-side with an area corresponding to a tire side section of a tire component member, making the annular recess cover the area, and reducing pressure in a space in-between;

FIG. 5 is an enlarged partial vertical sectional view illustrating a step of pressing the side member against the area corresponding to the tire side section;

FIG. 6 is an enlarged partial vertical sectional view illustrating a step in which the holding part is retracted; and

FIG. 7 is an enlarged partial vertical sectional view illustrating a molded green tire.

### DETAILED DESCRIPTION OF EMBODIMENTS

A pneumatic tire molding method and molding apparatus according to the present invention will now be explained based on embodiments shown in the drawings.

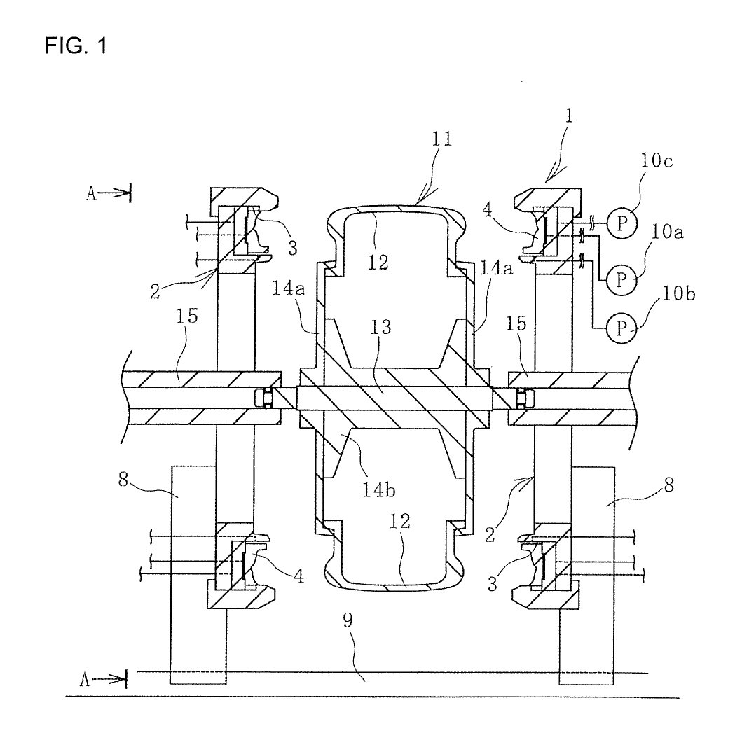

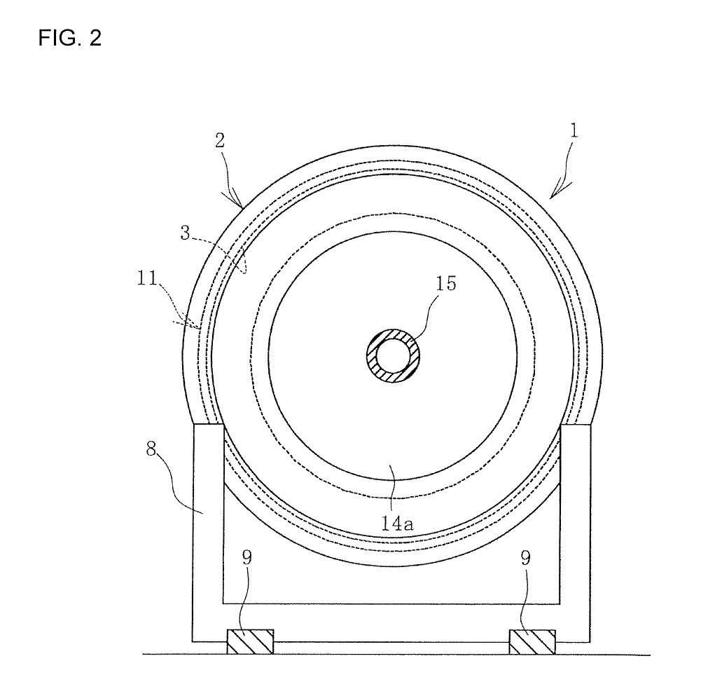

As shown in FIG. 1 and FIG. 2, the pneumatic tire molding apparatus 1 according to a disclosed embodiment (hereinafter called “molding apparatus 1”) is an apparatus used to mold a green tire G on an external circumference of a rigid inner mold 11. Tire component members are successively attached to each other on the exterior circumferential surface of the rigid inner mold 11 to complete the green tire G.

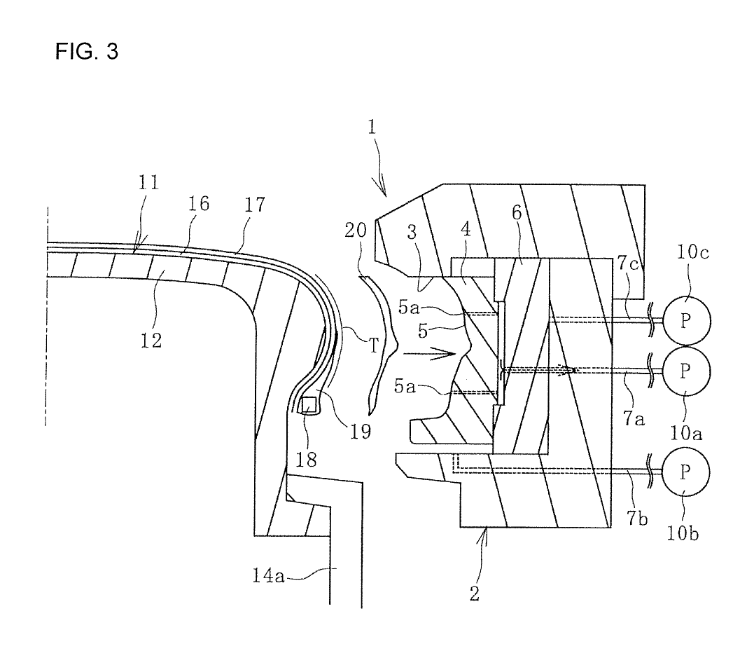

An inner liner 16 and a carcass member 17 are layered successively on the external circumferential surface of the rigid inner mold 11 as shown in FIG. 3. Carcass material 17 is draped between a pair of bead rings 18 and folded around the bead rings 18 from inside to outside so as to sandwich a bead filler 19.

This rigid inner mold 11 has a circular cylindrical shape and comprises a plurality of divided bodies 12 that are divided along a circumferential direction. The material used for the rigid inner mold 11 is, for example, aluminum, an aluminum alloy, or another metal material. The exterior circumferential surface of the rigid inner mold 11 has substantially the same shape as an internal circumferential surface of a tire to be manufactured (tire that will result after vulcanization is completed). The divided bodies 12 are arranged in a circular cylindrical shape and fixed to circumferential edge portions of circular disk-like support plates 14a arranged facing across from each other.

A center shaft 13 is fixed to the support plates 14a such that it passes through circular center positions of the support plates 14a. The center shaft 13 is fixed to the pair of support plates 14a through support ribs 14b that are fixed to an external circumferential surface of the center shaft 13. In this way, the divided bodies 12 are attached to complete the rigid inner mold 11 such that it can be disassembled. Both ends of the center shaft 13 are rotatably supported in holding shafts 15. As a result, the rigid inner mold 11 can rotate about the center shaft 13.

The molding apparatus 1 comprises a pair of annular holders 2 arranged on both sides of the rigid inner mold 1. Each of the annular holders 2 is supported on a holder support section 8 such that it can move along a guide rail 9. By moving along the rails 9, the annular holders 2 move in directions of approaching toward and separating away from the side faces of the rigid inner mold 11 (i.e., an area T corresponding to a tire side section of the tire component member arranged on the external circumferential surface of the rigid inner mold 11).

Each of the annular holders 2 has an annular recess 3 in the side face thereof that faces toward the rigid inner mold 11. The recess 3 is configured and arranged such that it can cover the area T corresponding to the tire side section when it is moved toward the side face of the rigid inner mold 11. An air flow passage 7b is provided such that it communicates with the recess 3. The air flow passage 7b is connected to a pump 10b and functions as a suction line.

A holding part 4 and a sliding part 6 are arranged inside the recess 3. The sliding part 6 is arranged abutting against a back face of the holding part 4. The holding part 4 and the sliding part 6 are provided such that they can slide in directions of approaching toward and separating from a side face of the rigid inner mold 11.

The holding part 4 holds a side member 20 that is a component member of the tire. The holding part 4 has a holding surface 5 that has the same shape as a surface of the side member 20. The holding surface 5 is placed on the surface of the side member 20 and the annular side member 20 is held by the holding part 4. It is acceptable for the side member 20 to be provided as a unit with a chafer and other components.

In this embodiment, suction holes 5a are opened in the holding surface 5 and the suction holes 5a communicate with an air passage 7a that passes through the siding section 6. The air flow passage 7a is connected to a pump 10a and functions as a suction line.

An air passage 7c communicates with a back side of the sliding part 6. This air flow passage 7c is connected to a pump 10c. When air is pumped through the air flow passage 7c by driving the pump 10c, the sliding part 6 is pushed by a pneumatic pressure. As a result, the sliding part 6 and the holding part 4 move (advance) in a direction of approaching the side face of the rigid inner mold 11. When air is sucked through the air flow passage 7c by driving the pump 10c, the sliding part 6 is pulled by a pneumatic pressure. As a result, the sliding part 6 and the holding part 4 move (retract) in a direction of separating from the side face of the rigid inner mold 11. Thus, the sliding part 6, the air flow passage 7c, and the pump 10c constitute a sliding mechanism that uses pneumatic pressure to slide the holding part 4 within the recess 3 in directions of approaching toward and separating from the area T corresponding to the tire side section.

While it is acceptable for the holding part 4 and the sliding part 6 to be a one-piece integral unit, in this embodiment they are provided as separate and independent parts. Side members 20 having differently shaped surfaces are used when green tires G having differently shaped sides are molded. By providing the holding part 4 and the sliding part 6 as separate parts, only the holding part 4 needs to be changed in order to mold a green tire having a differently shaped side.

A method of manufacturing a pneumatic tire using the molding apparatus 1 will now be explained.

As shown in FIG. 3, when the pump 10a is driven, air is sucked through the air flow passage 7a and the suction holes 5a (a vacuum is pulled). As a result, the surface of the side member 20 is sucked to the holding surface 5 such that the side member 20 is held by the holding part 4. This suction holding of the side member 20 is continued until the attachment of the side member 20 is completed. At this stage, the holding part 4 and the sliding part 6 are in a retracted position inside the recess 3. An inner liner 16, a carcass member 17, and other tire component members are arranged on the external circumferential surface of the rigid inner mold 11.

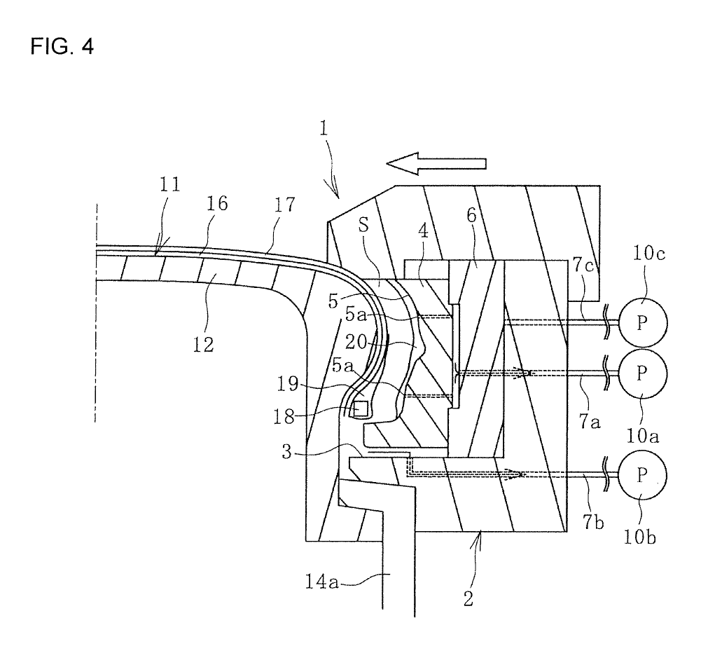

Next, as shown in FIG. 4, the annular holder 2 is moved into close proximity of the side face of the rigid inner mold 11 such that an inwardly-facing outer circumferential portion of the annular holder 2 contacts the carcass material 17 and an inwardly-facing inner circumferential portion of the annular holder 2 contacts the support plate 14a. As a result, the annular recess 3 is arranged side-by-side with and covers the area T corresponding to the tire side section of the tire component members arranged on the external surface of the rigid inner mold 11.

Next, the pump 10b is driven such that air is sucked from a space S between the recess 3 and the tire component member (carcass material 17) through the air flow passage 7b and the pressure is reduced (a vacuum is pulled) in the space S. For example, the space S is reduced to a pressure of 5 to 50 Pa (absolute).

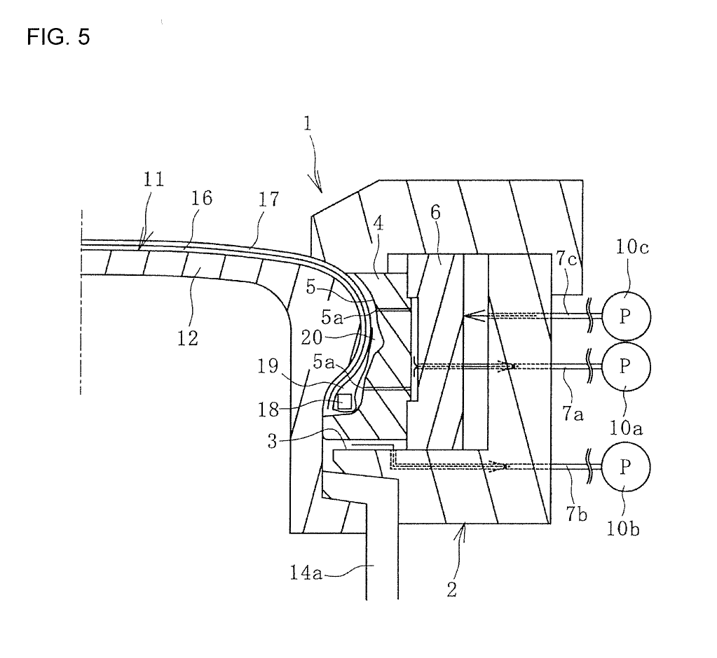

Next, as shown in FIG. 5, the pump 10c is driven while maintaining the pressure-reduced state of the space S such that air is pumped through the air flow passage 7c and the slide section 6 is slid toward the area T corresponding to the tire side section with pneumatic pressure. As a result, the side member 20 held by the holding part 4 is pressed against and attached to the area T corresponding to the tire side section.

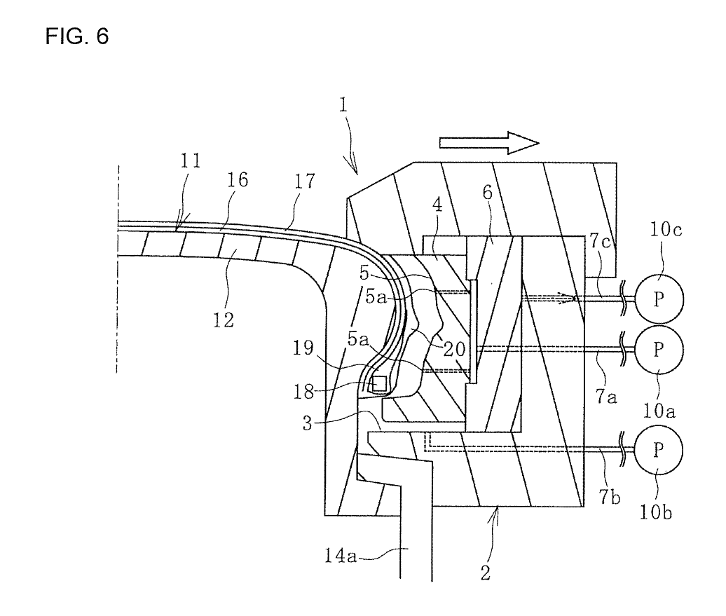

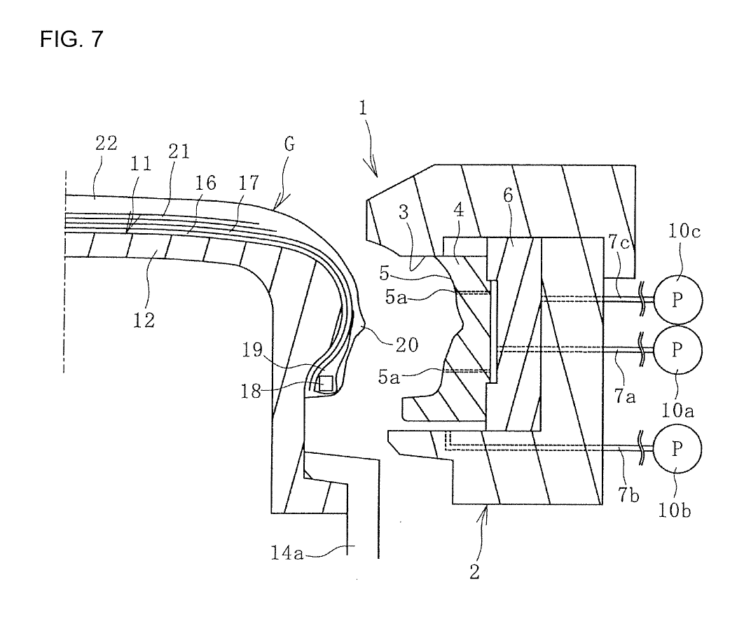

Next, as shown in FIG. 6, the pump 10c is driven such that air is sucked (a vacuum is pulled) through the air flow passage 7c and the slide section 6 and the holding part 4 are retracted. Then, the annular holder 2 is retracted such that it separates from the side face of the rigid inner mold 11. Next, as shown in FIG. 7, the remaining tire component members (belt layer 21 and tread member 22) are attached to the tire component members arranged on the external circumferential surface of the rigid inner mold 11 to complete the green tire G. The completed green tire G is placed together with the rigid inner mold 11 into a mold provided in a vulcanizing apparatus and vulcanized, or the rigid inner mold 11 is disassembled and removed from the green tire G and only the green tire G placed into a mold and vulcanized.

With the disclosed embodiments, since the tire component members are covered with the recess 3 and the space S is pulled to a reduced air pressure when the side member 20 is attached to the area T corresponding to the tire side section, it is not necessary to use a strong pressing force in order to prevent air from being trapped during the attachment. Additionally, since the surface of the side member 20 is held with a holding surface 5 having the same shape as the surface of the side member 20, the invention is advantageous from the standpoint of attaching the side member 20 with intimate contact while preventing the preset surface shape from being deformed, even if the side member 20 is made of un-vulcanized rubber that is easily deformed.

Although it is possible to simply hold the side member 20 with the holding part 4 without using suction holding, the side member 20 can be held more reliably without deforming its surface shape by holding it with suction as is done in this embodiment. Also, by sliding the holding part 4 with pneumatic pressure such that it slides toward the area T corresponding to the tire side section and presses against the side member 20, the side member 20 can be attached with intimate contact more reliably without applying excessive pressure against the side member 20.

A butyl rubber or a film can be used as the inner liner 16. If a film is used, then it is made of a thermoplastic resin or a thermoplastic resin blended with an elastomer to obtain a thermoplastic elastomer composition. The thickness is, for example, approximately 0.2 to 2.5 mm in the case of a butyl rubber and 0.005 to 0.2 mm in the case of a film. Consequently, using a film as the inner liner 16 contributes greatly to making the tire lighter in weight while also providing excellent air permeation prevention performance.

### GENERAL INTERPRETATION OF TERMS

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “outboard”, inboard”, “forward”, “rearward”, “above”, “downward”, “vertical”, “horizontal”, “below” and “transverse” as well as any other similar directional terms refer to those directions of a vehicle equipped with the present invention. Accordingly, these terms, as utilized to describe the present invention should be interpreted relative to a vehicle equipped with the present invention. The terms of degree such as “generally”, “substantially”, “about” and “approximately” as used herein mean a reasonable amount of deviation of the modified term such that the end result is not significantly changed. For example, two members that are angled less than ten degrees apart would be considered “generally perpendicular”, but two members that are angled more than fifteen degrees apart would not be considered “generally perpendicular”.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A pneumatic tire molding method for molding a green tire on an external circumference of a circular-cylindrically shaped rigid inner mold whose external circumferential surface has substantially the same shape as a profile of an internal circumferential surface of a tire to be manufactured, the method comprising:
arranging an annular recess formed in an annular holder to be side-by-side with an area corresponding to a tire side section of a tire component member that is arranged on the external circumferential surface of the rigid inner mold so as to cover the area;
removing air from a space between the recess and the tire component member covered by the recess so as to reduce a pressure of the space;
holding a surface of a side member with a holding part having a holding surface that has the same shape as the surface of the side member;
pressing the side member against and attaching the side member to the area corresponding to the tire side section under the pressure-reduced state; and
molding a green tire by attaching remaining tire component members to the tire component member arranged on the external circumferential surface of the rigid inner mold.

2. The pneumatic tire molding method according to claim 1, wherein
during the holding of the surface of the side member with the holding part, adhering the side member to the holding surface with suction by sucking air through a suction hole open in the holding surface.

3. The pneumatic tire molding method according to claim 1, further comprising
sliding the holding part within the recess toward the area corresponding to the tire side section using pneumatic pressure such that the side member is pressed against the area corresponding to the tire side section.

4. The pneumatic tire molding method according to claim 2, further comprising
sliding the holding part within the recess toward the area corresponding to the tire side section using pneumatic pressure such that the side member is pressed against the area corresponding to the tire side section.

5. The pneumatic tire molding method according to claim 3, further comprising
positioning a sliding part between the annular holder and the holding part in the annular recess before arranging the annular recess to be side-by-side with the area; and
wherein the sliding includes sliding the sliding part to slide the holding part.

6. The pneumatic tire molding method according to claim 4, further comprising
positioning a sliding part between the annular holder and the holding part in the annular recess before arranging the annular recess to be side-by-side with the area; and
wherein the sliding includes sliding the sliding part to slide the holding part.

7. The pneumatic tire molding method according to claim 1, further comprising
retracting the annular holder from the tire side section after pressing the side member against and attaching the side member to the area and before molding the green tire by attaching the remaining tire component members.

8. The pneumatic tire molding method according to claim 7, further comprising
retaining the holding part in the annular recess when retracting the annular holder from the tire side section.

9. A pneumatic tire molding apparatus for molding a green tire on an external circumference of a circular-cylindrically shaped rigid inner mold whose external circumferential surface has substantially the same shape as a profile of an internal circumferential surface of a tire to be manufactured, the pneumatic tire molding apparatus comprising:
an annular holder configured to move in directions of approaching toward and separating from an area corresponding to a tire side section of a tire component member arranged on the external circumferential surface of the rigid inner mold, the annular holder defining an annular recess that is configured to cover the area corresponding to the tire side section;
a pump coupled to the recess through a suction line that communicates with the recess; and
a holding part that is arranged inside the recess, has a holding surface shaped the same as a surface of the side member, and is configured to hold the holding surface with the surface of the side member.

10. The pneumatic tire molding apparatus according to claim 9, wherein
the holding surface defines a suction hole configuration open in the holding surface; and
the pneumatic tire molding apparatus further comprises a second pump that sucks air through the suction hole configuration.

11. The pneumatic tire molding apparatus according to claim 9, further comprising
a sliding mechanism that uses pneumatic pressure to slide the holding part within the recess in the directions of approaching toward and separating from the area corresponding to the tire side section.

12. The pneumatic tire molding apparatus according to claim 10, further comprising
a sliding mechanism that uses pneumatic pressure to slide the holding part within the recess in the directions of approaching toward and separating from the area corresponding to the tire side section.

13. The pneumatic tire molding apparatus according to claim 11, wherein
the sliding mechanism is positioned between the holding part and a surface of the annular holder defining the recess.

14. The pneumatic tire molding apparatus according to claim 12, wherein
the sliding mechanism includes an opening that communicates with the suction hole configuration in the holding surface; and
the second pump communicates with the opening to suck air through the suction hole configuration via the opening.

15. The pneumatic tire molding apparatus according to claim 14, wherein
the suction hole configuration includes a plurality of suction holes open in the holding surface; and
the second pump communicates with the opening in the sliding mechanism to suck air through the plurality of suction holes via the opening.

16. The pneumatic tire molding apparatus according to claim 9, wherein
the pump provides a suction to the recess through the suction line to reduce pressure within an area defined by a surface of the annular holder and the surface of the side member.

17. The pneumatic tire molding apparatus according to claim 16, wherein
an inside side surface of the annular holder and an outside side surface of the holding part define a gap, and the inside side surface of the annular holder further defines an opening that communicates with the gap such that the pump provides the suction to the recess via the opening and the gap.

18. The pneumatic tire molding apparatus according to claim 9, further comprising
a third pump that provides one of suction through an opening in a surface of the annular holder defining the recess to move the holding part in the direction of separating from the area corresponding to the tire side section and air pressure through the opening in the surface of the annular holder to move the holding part in the direction of approaching toward the area corresponding to the tire side section.

19. The pneumatic tire molding apparatus according to claim 18, wherein
the third pump provides the air pressure through the opening in the surface of the annular holder defining the recess to hold the holding surface with the surface of the side member.

20. The pneumatic tire molding apparatus according to claim 18, wherein
the third pump provides the suction through the opening in the surface of the annular holder defining the recess to retain the holding part in the recess while the annular holder moves in the direction of separating from the area corresponding to the tire side section.
